(19) United States
(12) Patent Application Publication
(10) Pub. No.: US 2010/0272498 A1
(43) Pub. Date: Oct. 28, 2010

(54) APPARATUS FOR MOISTENING PORTIONS OF ARTICLES

(76) Inventors: Debra Crocitto, Hicksville, NY (US); Peter S. Crocitto, Hicksville, NY (US)

Correspondence Address: L.C. BEGIN & ASSOCIATES, PLLC, 510 HIGHLAND AVENUE, PMB 403, MILFORD, MI, 48381, US

(21) Appl. No.: 12/582,172

(22) Filed: Oct. 20, 2009

Related U.S. Application Data
(60) Provisional application No. 61/171,870, filed on Apr. 23, 2009.

(51) Int. Cl. B43M 11/08

(52) U.S. Cl. 401/202

(57) ABSTRACT

An apparatus for moistening a portion of an article includes an elongated reservoir carrying a moistening fluid. The apparatus further includes an applicator assembly removably coupled with a first open end portion of the elongated reservoir, and configured in fluid communication with the elongated reservoir. The applicator assembly includes an applicator adapted to discharge the moistening fluid from within the elongated reservoir when the applicator is pressed against the portion of the article. Furthermore, the apparatus includes a lid member detachably secured to a second open end portion of the elongated reservoir. In addition, the apparatus includes a cap member detachably secured to one of the applicator assembly and the lid member for covering one of the applicator and the lid member. Moreover, the apparatus includes a securing member attached to one of the elongated reservoir and the cap member for enabling a user to secure the apparatus.

### CROSS REFERENCE TO RELATED APPLICATION

This application claims the benefit of U.S. Provisional Application No. 61/171,870 filed on Apr. 23, 2009, the disclosure of which is incorporated by reference.

### FIELD OF THE DISCLOSURE

The present disclosure relates generally to apparatuses for moistening portions of articles, such as envelopes, and more particularly, to an apparatus for moistening a portion of an article, provided with a layer of a dormant form of an adhesive.

### BACKGROUND OF THE DISCLOSURE

Nowadays, staying away from family, friends and other relatives for work and other purposes is very common among people. Conventionally, people mail various articles such as envelopes enclosing letters, and packages to their relatives and/or friends for communication while staying away from home or office. Further, some people may need to mail a large number of confidential letters, invitation cards for various occasions, holiday cards, and the like in different types of articles including envelopes and packages. In such cases, proper sealing of the envelopes and packages is very essential to avoid any loss of information or item enclosed therewithin.

In general, some people may utilize adhesives to seal envelopes and packages, and to paste other articles such as stamps on the envelopes. Accordingly, a user may need to carry an adhesive whenever he or she is in need of sealing or pasting various articles. Alternately, some articles are provided with layers of an adhesive in a dormant form disposed on selective portions of the articles that need to be moistened with water for activating the adhesive for sealing or pasting purposes. Specifically, a user may utilize a water sprayer or a damp material to activate the adhesive. However, it has been observed that such utilization of the water sprayer or the damp material may result in dripping of water onto the articles, thereby creating watermarks either on the articles or on the items enclosed therewithin. Further, such dripping may also create a mess within the confines of a work area.

It has further been observed that some people tend to lick a flap of an envelope in order to moisten a dormant adhesive layer disposed on the flap of the envelope for sealing the envelope. Similarly, people tend to lick dormant adhesive layers that may be provided at rear portions of stamps in order to paste the stamps on envelopes. However, many people dislike an undesirable aftertaste that is left in their mouth after licking the adhesive layers. Furthermore, licking of selective portions of articles, such as stamps, may be harmful as it may lead to bruises on a user's lips or tongue.

### SUMMARY OF THE DISCLOSURE

An apparatus for moistening a portion of an article includes an elongated reservoir carrying a moistening fluid. The apparatus further includes an applicator assembly that is removably coupled with a first open end portion of the elongated reservoir. Additionally, the applicator assembly is configured in fluid communication with the elongated reservoir for receiving the moistening fluid from within the elongated reservoir. The applicator assembly includes an applicator for discharging the moistening fluid received from within the elongated reservoir when the applicator is pressed against the portion of the article. Furthermore, the apparatus includes a lid member that is detachably secured to a second open end portion opposite to the first open end portion of the elongated reservoir. Moreover, the apparatus includes a cap member that is detachably secured to the applicator assembly for covering the applicator assembly. The same cap member may be detachably attached to the lid member when removed from the applicator assembly. Still further, the apparatus includes a securing member that is attached to one of the elongated reservoir and the cap member for enabling a user to secure the apparatus.

### BRIEF DESCRIPTION OF THE DRAWINGS

These advantages and other features and advantages of the present disclosure will be apparent from the following detailed description of preferred embodiments and best mode, appended claims and accompanying drawings in which:

FIG. 1 is a perspective view of one embodiment of an apparatus for moistening a portion of an article;

FIG. 2 is an exploded view of the apparatus of FIG. 1;

FIG. 3 is a perspective view of another embodiment of the apparatus of FIG. 1; and

FIG. 4 is a perspective view of the apparatus of FIG. 1 being utilized for moistening a portion of an article.

Like reference numerals refer to like parts throughout the description of several views of the drawings.

### DETAILED DESCRIPTION OF THE DISCLOSURE

The exemplary embodiments described herein in detail for illustrative purposes are subject to many variations in composition, structure, and design. It should be emphasized, however, that the present disclosure is not limited to a particular apparatus for moistening a portion of an article, as shown and described. It is understood that various omissions and substitutions of equivalents are contemplated as circumstances may suggest or render expedient, but these are intended to cover the application or embodiment without departing from the spirit or scope of the claims of the present disclosure. Also, it is to be understood that the phraseology and terminology used herein are for the purpose of description and should not be regarded as limiting.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced items.

The present disclosure provides an apparatus for moistening a portion of an article, such as an envelope, a stamp, and the like. The term “portion of the article” may relate to a portion that includes a layer/coating of an adhesive, which may be applied on the portion of the article in a dormant form or a dry form, and accordingly, the adhesive may need to be activated using a moistening fluid such as water.

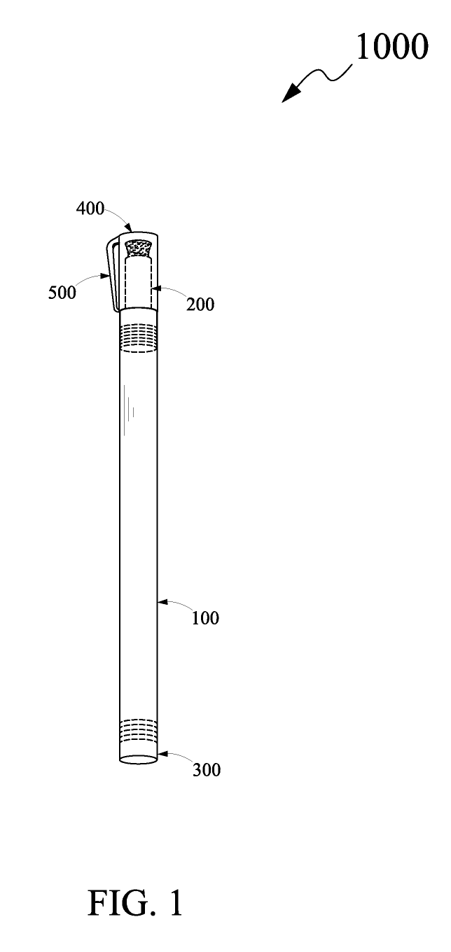

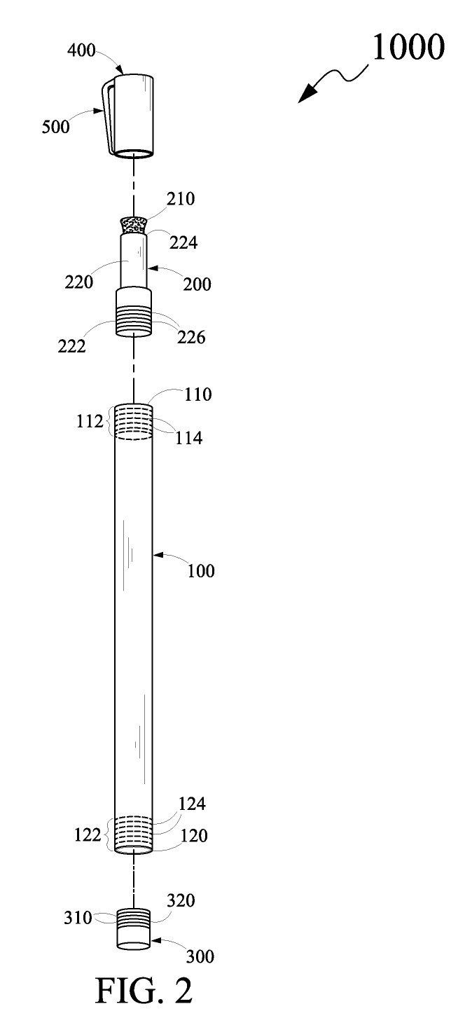

The apparatus of the present disclosure includes an elongated reservoir carrying a moistening fluid, an applicator assembly removably coupled with the elongated reservoir, a lid member detachably secured to the elongated reservoir, a cap member detachably secured onto one of the applicator assembly and the lid member, and a securing member attached to one of the elongated reservoir and the cap member. One embodiment of the apparatus of the present disclosure is explained in conjunction with FIGS. 1 and 2.

FIG. 1 is a perspective view of one embodiment of an apparatus 1000 for moistening a portion of an article. Further, FIG. 2 illustrates an exploded view of the apparatus 1000.

The apparatus 1000 includes an elongated reservoir 100, an applicator assembly 200, a lid member 300, a cap member 400, and a securing member 500 (as shown in FIGS. 1 and 2).

The elongated reservoir 100 includes a first open end portion 110 and a second open end portion 120 opposite to the first open end portion 110. The elongated reservoir 100 carries a moistening fluid (not shown). A suitable example of the moistening fluid includes, but is not limited to, water. The moistening fluid is capable of moistening the portion of the article that is provided with a layer of an adhesive in a dormant form. The moistening fluid may be filled within the elongated reservoir 100 using one of the first open end portion 110, the second open end portion 120, or both.

The first open end portion 110 includes a first threaded groove 112 and the second open end portion 120 includes a second threaded groove 122. Further, the first threaded groove 112 includes a plurality of first threads 114 and the second threaded groove 122 includes a plurality of second threads 124.

The elongated reservoir 100 may be made of a light weight, a hard, and a durable material, such as a plastic material. Alternately, the elongated reservoir 100 may be made of any other light weight, a hard, and a durable material known in the art capable of carrying a moistening fluid, such as water.

The applicator assembly 200 of the apparatus 1000 is removably coupled with the first open end portion 110 of the elongated reservoir 100. Further, the applicator assembly 200 is configured in fluid communication with the elongated reservoir 100 for receiving the moistening fluid from within the elongated reservoir 100. The applicator assembly 200 may be removably coupled to the elongated reservoir 100 in such a way that the applicator assembly 200 and the elongated reservoir 100 configure an elongated cavity (not shown) for allowing the moistening fluid to be received into the applicator assembly 200 from within the elongated reservoir 100. The applicator assembly 200 includes an applicator 210, and a supporting member 220 including a first end portion 222 and a second end portion 224 opposite to the first end portion 222.

The applicator 210 extends outwardly from the second end portion 224 of the supporting member 220. The applicator 210 is composed of a fluid absorbent material, and specifically, a sponge-like material. Further, the applicator 210 is replaceable. Specifically, the applicator 210 is capable of being replaced with a new applicator, such as the applicator 210, when the applicator 210 undergoes wear and tear after a prolonged usage.

As described above, the supporting member 220 includes the first end portion 222 and the second end portion 224. The second end portion 224 is an open end portion to enable the applicator 210 to extend outwardly from the supporting member 220. Further, the first end portion 222 is configured to include a plurality of complementary threads 226 for engaging with the first threads 114 of the first threaded groove 112 of the elongated reservoir 100. Such an engagement facilitates the applicator assembly 200 to removably couple with the first open end portion 110 of the elongated reservoir 100.

The supporting member 220 may be made of a light weight, a hard, and a durable material, such as a plastic material. Alternately, the supporting member 220 may be made of any other light weight, a hard, and a durable material known in the art.

The lid member 300 of the apparatus 1000 is detachably secured to the second open end portion 120 of the elongated reservoir 100 for closing the second open end portion 120. The lid member 300 includes a plurality of complementary threads 310 configured at an end portion 320 of the lid member 300. Specifically, the complementary threads 310 are configured to engage with the second threads 124 of the second threaded groove 122 of the elongated reservoir 100. Such an engagement facilitates the lid member 300 to detachably secure to the second open end portion 120 of the elongated reservoir 100. Further, the lid member 300 may enable the apparatus 1000 to rest vertically on a flat surface (not shown).

The lid member 300 may be made of a light weight, a hard, and a durable material, such as a plastic material. Alternately, the lid member 300 may be made of any other light weight, a hard, and a durable material known in the art.

The cap member 400 of the apparatus 1000 may be detachably secured onto the applicator assembly 200 for covering the applicator 210. Similarly, the cap member 400 further may be detachably secured onto the lid member 300 when removed from the applicator assembly 200. Specifically, the cap member 400 is capable of being snugly fitted onto both the applicator assembly 200 and the lid member 300. The cap member 400 is detachably secured onto the applicator assembly 200 when the apparatus 1000 is not in use. Further, use of the cap member 400 prevents the applicator 210 from getting dry. Furthermore, the cap member 400 may be detached from the applicator assembly 200 for utilizing the applicator 210. While using the applicator 210 for moistening the portion of the article, the cap member 400 may be optionally secured onto the lid member 300. Accordingly, detachably securing the cap member 400 onto the lid member 300 while using the applicator 210 prevents any loss of the cap member 400, which may then again be secured onto the applicator assembly 200 after utilizing the apparatus 1000.

Further, a clearance may exist between the cap member 400 and the applicator 210 when the cap member 400 is detachably secured onto the applicator assembly 200, in order to prevent any damage to the applicator 210.

A securing member 500 of the apparatus 1000 is attached to the cap member 400 (as shown in FIGS. 1 and 2) for securing the apparatus 1000. The securing member 500 enables the user to secure the apparatus 1000 to one of an item (not shown) and on or around a portion of the user's body (not shown). The term, “item” as used herein may relate to items such as the user's clothing including a pocket of the user's shirt and a pocket of the user's trouser. Further, the term, “portion of the user's body” may relate to portions, such as the user's neck portion.

The securing member 500 is in the form of a clip. It should be evident that the securing member 500 may be of various other shapes and configurations. For example, the securing member 500 may be a threaded loop and the like, such that the securing member 500 enables the user to secure the apparatus 1000 onto the portion of the user's body, in order to wear the apparatus 1000. Further, the threaded loop may enable the user to hang the apparatus 1000 on an element, such as a nail mounted on a wall, for securing the apparatus 1000 thereto. Furthermore, the apparatus 1000 may be utilized for moistening the portion of the article even when the apparatus 1000 is secured to the one of the item and the portion of the user's body. For example, the apparatus 1000 may be utilized even when the securing member 500 is worn by the user around his or her neck.

Further, the securing member 500 is made of a light weight, a hard, and a durable material, such as a plastic material. Alternately, the securing member 500 may be made of any other light weight, a hard, and a durable material known in the art.

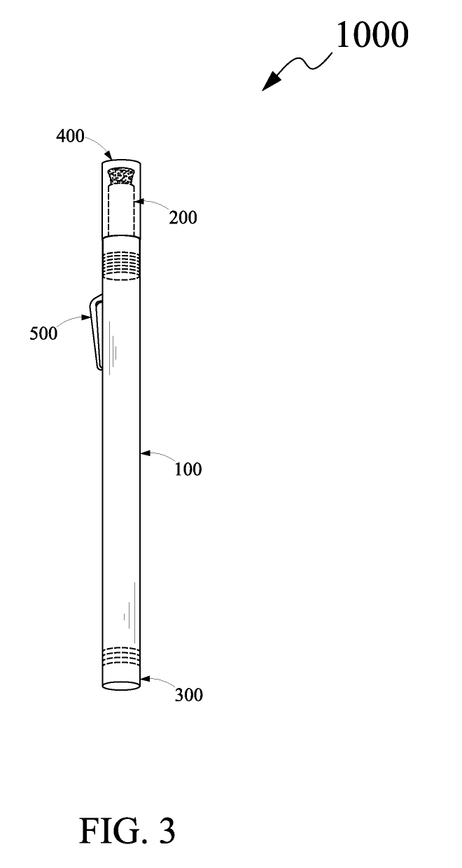

Referring now to FIG. 3, a perspective view of another embodiment of the apparatus 1000 is shown. The apparatus 1000 includes the elongated reservoir 100, the applicator assembly 200, the lid member 300, the cap member 400, and the securing member 500 attached to the elongated reservoir 100. The elongated reservoir 100, the applicator assembly 200, the lid member 300, the cap member 400, and the securing member 500 have been explained in conjunction with FIGS. 1 and 2, and accordingly, description thereof is avoided, for the sake of brevity.

The apparatus 1000 of the present disclosure may be cylindrical in shape as shown in FIGS. 1 to 3. Further, the elongated reservoir 100, the applicator assembly 200, the lid member 300, the cap member 400, and the securing member 500, may be of various designs and dimensions, as per a manufacturer's preference.

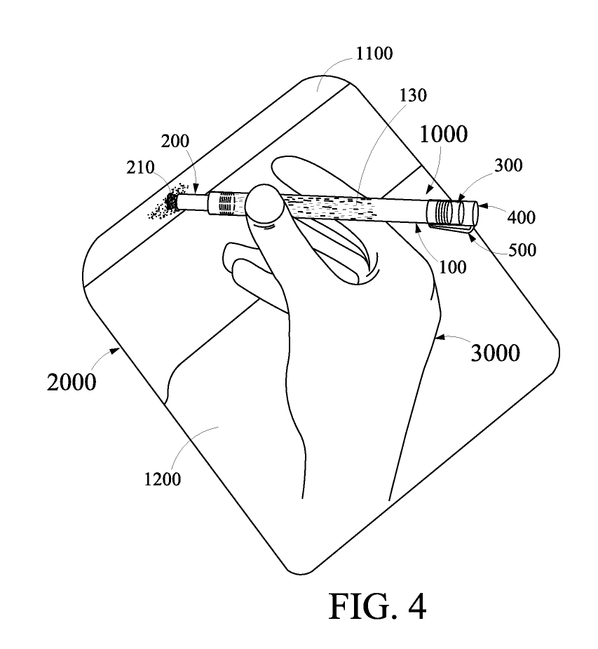

Referring now to FIG. 4, a perspective view of the apparatus 1000 being utilized for moistening a portion of an article, such as an envelope, is shown, in accordance with one embodiment. Specifically, FIG. 4 shows the apparatus 1000 having the securing member 500 attached to the cap member 400, an envelope 2000, a portion 1100 of the envelope 2000 and a hand 3000 of a user (not shown). The portion 1100 of the envelope 2000 is specifically a portion of a flap (not numbered) of the envelope 2000. Further, the portion 1100 of the envelope 2000 includes a layer of adhesive in a dormant form disposed thereon.

For description of FIG. 4, reference will be made to the elongated reservoir 100, the applicator assembly 200, the lid member 300, the cap member 400, and the securing member 500, as explained in conjunction with FIGS. 1 and 2, in accordance with one embodiment. It should be evident that another embodiment of the apparatus 1000, as explained in FIG. 3, may also be utilized in a manner as described below for moistening the portion 1100 of the envelope 2000.

As shown in FIG. 4, the elongated reservoir 100 includes a moistening fluid 130. The moistening fluid 130 may be filled within the elongated reservoir 100 either from the first open end portion 110 or from the second open end portion 120. Prior to filling the moistening fluid 130 from the first open end portion 110, the applicator assembly 200 is allowed to be detached from the elongated reservoir 100 by disengaging the complementary threads 226 from the first threaded groove 112, and the lid member 300 is retained to be detachably secured to the elongated reservoir 100.

Alternately, prior to filling the moistening fluid 130 from the second open end portion 120, the lid member 300 is allowed to be detached from the elongated reservoir 100 by disengaging the complementary threads 310 from the second threaded groove 122, and the applicator assembly 200 is retained to be removably coupled with the first open end portion 110.

Once the moistening fluid 130 is filled into the elongated reservoir 100, the applicator assembly 200 is removably coupled with the first open end portion 110 of the elongated reservoir 100, and the lid member 300 is detachably secured to the second open end portion 120 of the elongated reservoir 100, the applicator 210 may be utilized for moistening the portion 1100 of the envelope 2000.

Specifically, the user may hold the apparatus 1000 in his or her hand 3000 for pressing the applicator 210 against the portion 1100 (as shown in FIG. 4). Application of pressure against the portion 1100 facilitates the applicator 210 to discharge the moistening fluid 130 onto the portion 1100. The adhesive of the layer may be activated by the moistening fluid 130, and subsequently, the adhesive may be utilized to seal the envelope 2000, and specifically, to seal the portion 1100 with a base member 1200 of the envelope 2000.

In addition, the cap member 400 may be detachably secured onto the lid member 300 while the applicator 210 is being used for moistening the portion 1100 of the envelope 2000 (as shown in FIG. 4).

As described above, the present disclosure provides an easy-to-use apparatus, such as the apparatus 1000, for moistening a portion of an article, such as an envelope and a stamp. The apparatus includes an elongated reservoir, such as the elongated reservoir 100, which may be filled with a moistening fluid from either of open end portions thereof. Further, the apparatus provides a securing member, such as the securing member 500, which may be attached to one of the elongated reservoir and a cap member, such as the cap member 400. The securing member provides flexibility to a user for securing the apparatus to any item or to a portion of the user's body. Further, the cap member protects the applicator, such as the applicator 210, from any damage and further prevents drying of the applicator when the applicator is moistened by the moistening fluid. Furthermore, the applicator is replaceable in case of any wear and tear thereof. In addition, the elongated reservoir may be refilled with the moistening fluid once the previously filled moistening fluid has been completely utilized. Accordingly, the apparatus of the present disclosure is a reusable apparatus. In addition, the apparatus as disclosed hereinabove is a light weight apparatus, and is portable.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present disclosure.

What is claimed is:

1. An apparatus for moistening a portion of an article, the apparatus comprising:
an elongated reservoir carrying a moistening fluid;
an applicator assembly removably coupled with a first open end portion of the elongated reservoir, and configured in fluid communication with the elongated reservoir for receiving the moistening fluid from within the elongated reservoir, the applicator assembly comprising an applicator adapted to discharge the moistening fluid received from within the elongated reservoir when the applicator is pressed against the portion of the article;
a lid member detachably secured to a second open end portion opposite to the first open end portion of the elongated reservoir for closing the second open end portion;
a cap member detachably secured onto one of the applicator assembly and the lid member for covering one of the applicator and the lid member; and
a securing member attached to one of the elongated reservoir and the cap member for enabling a user to secure the apparatus.

2. The apparatus of claim 1, wherein the elongated reservoir comprises a first threaded groove configured at the first open end portion thereof, the first threaded groove comprising a plurality of first threads, and wherein the applicator assembly further comprises a supporting member having a plurality of complementary threads configured at a first end portion thereof for engaging with the plurality of first threads of the first threaded groove to removably couple the applicator assembly with the first open end portion of the elongated reservoir.

3. The apparatus of claim 2, wherein the applicator is extending outwardly from a second end portion opposite to the first end portion of the supporting member.

4. The apparatus of claim 2, wherein the elongated reservoir further comprises a second threaded groove configured at the second open end portion thereof, the second threaded groove comprising a plurality of second threads, and wherein the lid member comprises a plurality of complementary threads configured at an end portion thereof for engaging with the plurality of second threads of the second threaded groove to detachably secure the lid member to the second open end portion of the elongated reservoir.

5. The apparatus of claim 1, wherein the cap member is capable of covering the applicator when the cap is detachably secured onto the applicator assembly.

6. The apparatus of claim 1, wherein the cap member is detachably secured onto the lid member when removed from the applicator assembly.

7. The apparatus of claim 1, wherein the article is an envelope.
